(19) United States
(12) Patent Application Publication
(10) Pub. No.: US 2016/0300440 A1
(43) Pub. Date: Oct. 13, 2016

(54) SYSTEM AND METHOD FOR ACCEPTING AND CREATING ELECTRONIC WAGERS

(71) Applicant: iPro, Inc., Incline Village, NV (US)

(72) Inventors: David ORTIZ, Newcastle, WA (US); Shanmugapriyan DEVARAJ, Portland, OR (US); Shanmugam CHINNASAMY, Bellevue, WA (US)

(21) Appl. No.: 14/684,099

(22) Filed: Apr. 10, 2015

(51) Int. Cl. G07F 17/32

(52) U.S. Cl. CPC G07F 17/3244; G07F 17/3211

(57) ABSTRACT

System and method for accepting and creating electronic wagers. A computer-implemented method includes displaying a list including available high-level categories, wherein the available high-level categories correspond to events that are subject to wagers within a gaming system, accessing first user input to select one of the available high-level categories from the list, responsive to a selected high-level category, displaying a list of available sub-categories of the selected high-level category, and accessing second user input to select one of the sub-categories from that list. The computer-implemented method also includes responsive to a selected sub-category, displaying a list of predetermined wagers corresponding to the selected high-level category and the selected sub-category, accessing third user input to select one of the predetermined wagers, and responsive to a selected predetermined wager, displaying a first window for accepting the selected predetermined wager and a second window for creating the selected predetermined wager.

### RELATED APPLICATIONS

This application is related to co-pending, commonly owned U.S. patent application Ser. No. ______, attorney docket IPRO-0001-01.01US, filed Apr. 10, 2015, entitled “Method and System for Seamless Transitions between Game Types for Portable Computer Systems” to Devaraj et al., and is hereby incorporated by reference herein in its entirety.

This application is related to co-pending, commonly owned U.S. patent application Ser. No. ______, attorney docket IPRO-0003-01.01US, filed Apr. 10, 2015, entitled “System and Method for On-line Wagering on Real Time Events” to Ortiz et al., and is hereby incorporated by reference herein in its entirety.

This application is related to co-pending, commonly owned U.S. Patent application Ser. No. ______, attorney docket IPRO-0004-01.01US, filed Apr. 10, 2015, entitled “System and Method for On-line Fantasy Wagering” to Ortiz et al., and is hereby incorporated by reference herein in its entirety.

This application is related to co-pending, commonly owned U.S. patent application Ser. No. ______, attorney docket IPRO-0005-01.01US, filed Apr. 10, 2015, entitled “System and Method for On-Line Multi-Player Interactive Wagering” to Devaraj et al., and is hereby incorporated by reference herein in its entirety.

This application is related to co-pending, commonly owned U.S. Patent application Ser. No. ______, attorney docket IPRO-0006-01.01US, filed Apr. 10, 2015, entitled “Graphical User Interface for On-Line Gaming” to Ortiz et al., and is hereby incorporated by reference herein in its entirety.

U.S. Pat. No. 8,790,176, entitled “System and Method for Real Time Interactive Entertainment” to Hopf and Ortiz, is hereby included by reference in its entirety.

### FIELD OF INVENTION

Embodiments of the present invention relate to the field of electronic applications for mobile computer systems. More specifically, embodiments of the present invention relate to systems and methods for accepting and creating electronic wagers.

### BACKGROUND

User displays and sequences of displays for on-line gaming under the conventional art are cumbersome and detract from a user's enjoyment of an on-line gaming experience.

### SUMMARY OF THE INVENTION

Therefore, what is needed are systems and methods for accepting and creating electronic wagers. What is additionally needed are systems and methods for accepting and creating electronic wagers that enable a player to create a wager in an on-line gaming system. A need also exists for systems and methods for accepting and creating electronic wagers that utilize effective and intuitive graphical user interfaces. Further, a need exists for systems and methods for accepting and creating electronic wagers that are compatible and complementary with existing systems and methods of on-line and/or mobile gaming. Embodiments of the present invention provide these advantages.

In accordance with a first method embodiment of the present invention, a computer-implemented method includes displaying, on a display coupled to the computer, a list including available high-level categories, wherein the available high-level categories correspond to events that are subject to wagers within a gaming system, accessing, at the computer, first user input to select one of the available high-level categories from the list of available high-level categories, responsive to a selected high-level category, displaying, on the display, a list of available sub-categories of the selected high-level category, and accessing, at the computer, second user input to select one of the sub-categories from the list of available sub-categories. The computer-implemented method also includes responsive to a selected sub-category, displaying, on the display, a list of predetermined wagers corresponding to the selected high-level category and the selected sub-category, accessing, at the computer, third user input to select one of the predetermined wagers, and responsive to a selected predetermined wager, displaying, on the display, a first window for accepting the selected predetermined wager and a second window for creating the selected predetermined wager.

In accordance with another embodiment of the present invention, an article of manufacture includes a computer readable medium having instructions stored thereon that, responsive to execution by an electronic system, cause the electronic system to perform operations. The operations include displaying, on a display coupled to the computer, a list including available high-level categories, wherein the available high-level categories correspond to events that are subject to wagers within a gaming system, accessing, at the computer, first user input to select one of the available high-level categories from the list, responsive to a selected high-level category, displaying, on the display, a list of available sub-categories of the selected high-level category, and accessing, at the computer, second user input to select one of the sub-categories from the list. The computer-implemented method also includes responsive to a selected sub-category, displaying, on the display, a list of predetermined wagers corresponding to the selected high-level category and the selected sub-category, accessing, at the computer, third user input to select one of the predetermined wagers, and responsive to a selected predetermined wager, displaying, on the display, a first window for accepting the selected predetermined wager and a second window for creating the selected predetermined wager.

In accordance with a further embodiment of the present invention, an electronic system includes one or more processors coupled to a bus, a memory coupled to the one or more processors, wherein the memory includes a gaming application, a position determining system coupled to the bus operable to determine a geolocation of the electronic system and a graphical user interface coupled to the bus. The graphical user interface is configured to display a list including available high-level categories, wherein the available high-level categories correspond to events that are subject to wagers within a gaming system, access first user input to select one of the available high-level categories from the list, responsive to a selected high-level category, display a list of available sub-categories of the selected high-level category, access second user input to select one of the sub-categories from the list, responsive to a selected sub-category, display a list of predetermined wagers corresponding to the selected high-level category and the selected sub-category, access third user input to select one of the predetermined wagers, and responsive to a selected predetermined wager, display a first window for accepting the selected predetermined wager and a second window for creating the selected predetermined wager.

### BRIEF DESCRIPTION OF THE DRAWINGS

The accompanying drawings, which are incorporated in and form a part of this specification, illustrate embodiments of the invention and, together with the description, serve to explain the principles of the invention. Unless otherwise noted, the drawings are not drawn to scale.

FIG. 1 illustrates an exemplary block diagram of an exemplary electronic system, which may be used as a platform to implement embodiments of the present invention.

FIG. 2 illustrates an exemplary graphical user interface (GUI) for selecting a wager, in accordance with embodiments of the present invention.

FIG. 3 illustrates an exemplary graphical user interface (GUI) for accepting and/or creating a wager, in accordance with embodiments of the present invention.

FIG. 4 illustrates an exemplary graphical user interface (GUI) for creating a wager, in accordance with embodiments of the present invention.

FIG. 5 illustrates an exemplary graphical user interface (GUI) for inviting friends to accept a bet created by a user, in accordance with embodiments of the present invention.

FIG. 6 illustrates an exemplary prefilled message inviting one or more individuals or groups to accept a wager, in accordance with embodiments of the present invention.

FIG. 7 illustrates an exemplary computer-implemented method, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### Notation and Nomenclature

Some portions of the detailed descriptions which follow (e.g., methods 700) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accepting” or “selecting” or “determining” or “displaying” or “computing” or “sending” or “receiving” or “reducing” or “detecting” or “setting” or “accessing” or “placing” or “testing” or “forming” or “mounting” or “removing” or “ceasing” or “stopping” or “coating” or “processing” or “performing” or “generating” or “adjusting” or “creating” or “executing” or “continuing” or “indexing” or “translating” or “calculating” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The terms “micro event” and “sub-event” are used to refer to or to describe an activity within a larger “event,” the outcome of which may be subject to a wager. For example, a football game may be considered an “event,” while individual plays within the game may be considered “micro events.” Similarly, a baseball game may be considered an “event,” while each pitch, and the resulting outcome, e.g., ball, strike, single, double, triple, home run, sacrifice fly, etc., may be considered a “micro event.” For games with a less defined play structure, e.g., basketball, a fixed duration of game time, e.g., five minutes, may constitute a “micro event.” Embodiments in accordance with the present invention are well suited to wagers based on events and micro events within such events.

### System And Method for Accepting and Creating Electronic Wagers

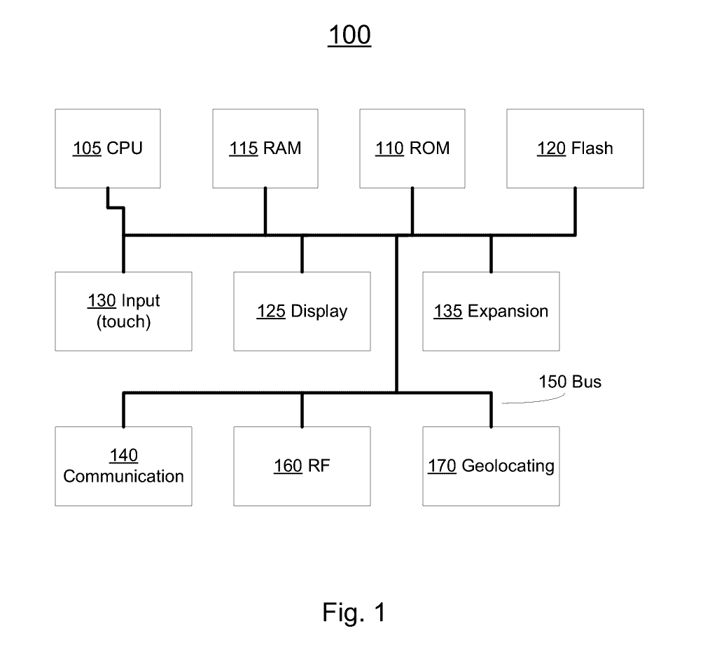

FIG. 1 illustrates an exemplary block diagram of an exemplary electronic system 100, which may be used as a platform to implement embodiments of the present invention. Electronic system 100 may be battery-powered, in some embodiments. Electronic system 100 may be a “server” computer system, in some embodiments. Electronic system 100 may comprise a desktop or generally “fixed location” computer system, in some embodiments. Electronic system 100 may comprise aportable computer system, e.g., a “smart” phone. Electronic system 100 may comprise a “wearable” computer system, e.g., a “smart” watch or an “eye-glasses-mounted” computer system. Electronic system 100 includes an address/data bus 150 for communicating information, a central processor 105 functionally coupled with the bus for processing information and instructions. Central processor 105 may comprise a single processor or multiple processors, e.g., a multi-core processor, or multiple separate processors, in some embodiments. Electronic system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Electronic system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in electronic system 100 of FIG. 1 is an optional input device 130. Device 130 can communicate information and command selections to the central processor 100. Input device 130 may be any suitable device for communicating information and/or commands to the electronic system 100. For example, input device 130 may take the form of a keyboard, buttons, a joystick, a track ball, an audio transducer, e.g., a microphone, a touch sensitive digitizer panel, eyeball scanner, and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the electronic system 100, in some embodiments. For example, capacitive touch panels may sense proximity of a user's finger or an eyeball scanner may detect a direction of a user's gaze.

The display unit 125 utilized with the electronic system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments. Display unit 125 may comprise a head-mounted display, in some embodiments.

A touch sensitive digitizer panel 130 is generally associated with the display unit 125. For example, a function of the touch sensitive digitizer panel 130 generally associated with the display unit 125 is to localize a touch input, e.g., from a finger and/or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100. A touch sensitive digitizer panel is not required.

Electronic system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express(PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may comprise signals substantially compliant with the signals of bus 150.

A wide variety of well-known devices may be attached to electronic system 100 via the bus 150 and/or expansion interface 135. Examples of such devices include without limitation rotating magnetic memory devices, flash memory devices, digital cameras, wireless communication modules, digital audio players, and Global Positioning System (GPS) devices.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394, and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of electronic system 100 may be implemented by a combination of hardware and/or software. Electronic system 100 may comprise additional software and/or hardware features (not shown) in some embodiments.

Various modules of system 100 may access computer readable media, and the term is known or understood to include removable media, for example, Secure Digital (“SD”) cards, CD and/or DVD ROMs, diskettes and the like, as well as non-removable or internal media, for example, hard drives, RAM, ROM, flash, and the like.

Electronic system 100 may comprise one or more geolocation determining features 170. For example, electronic system 100 may determine its position by use of a Global Positioning System (GPS), including, for example, the United States Global Position System, the planned European Union Galileo positioning system, India's Indian Regional Navigational Satellite System and/or the Chinese Compass navigation system. Electronic system 100 may also determine its position via a mobile telephone network, for example, identifying, measuring signal strength, and/or triangulation of cell towers. Electronic system 100 may also determine its position from known locations of wireless networks, e.g., WiFi hotspots, from an internet protocol (IP) address, or any other applicable location service(s). Geolocation determining features 170 may comprise dedicated hardware, or may utilize components with one or more other uses.

In accordance with embodiments of the present invention, systems and methods for accepting and creating electronic wagers enable a user or “player” to make and/or accept an electronic wager via an electronic system, e.g., a “smart” phone. A player may post potential wagers, e.g., wagers proposed by the player, and/or select from among wagers posted by other players. A “player” may be a natural person, a wager host, e.g., an on-line casino, etc., a computer system, e.g., a “betting robot,” or other such entity. For example, a natural person may post a potential wager via embodiments in accordance with the present invention, seeking another player to accept such wager. An on-line casino may accept the wager. Similarly, an on-line casino may post a potential wager, and a natural person may, via embodiments in accordance with the present invention, accept the wager. Of course, two natural persons, e.g., some distance apart, using separate computers, may propose and accept, respectively, a wager, in accordance with embodiments of the present invention. All such combinations are to be considered within the scope of the present invention.

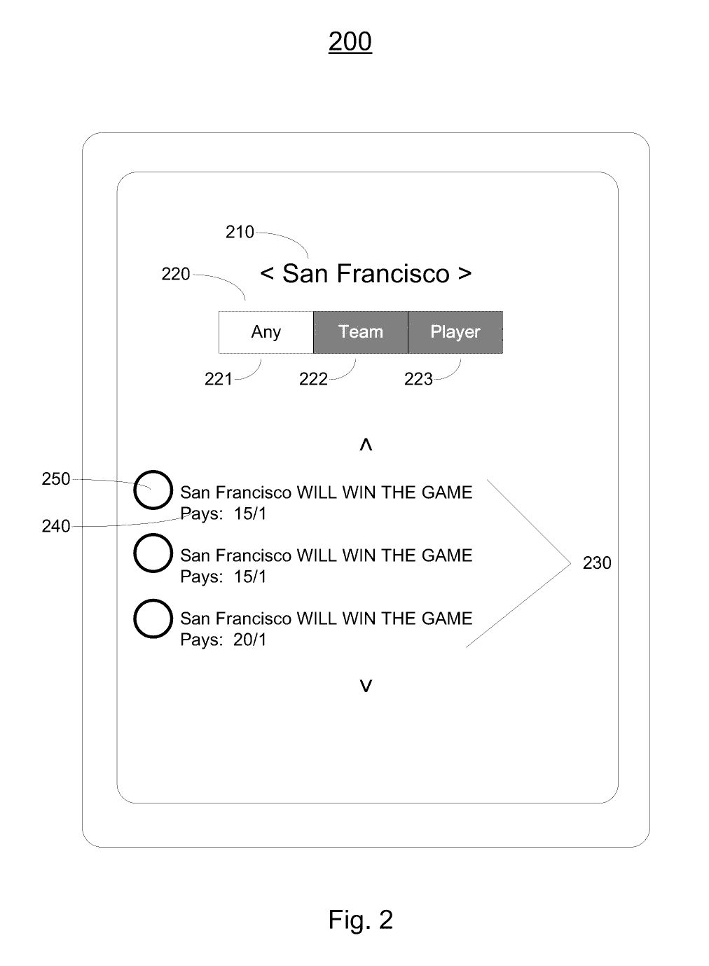

FIG. 2 illustrates an exemplary graphical user interface (GUI) 200 for selecting a wager, in accordance with embodiments of the present invention. Graphical user interface 200 may be displayed, for example, on display unit 125 of electronic system 100, as illustrated in FIG. 1. User input to the electronic system 100 may be accepted from a touch sensitive digitizer panel, e.g., touch sensitive digitizer panel 130 of FIG. 1, an attached keyboard, voice recognition, eye tracking, spatial gesture recognition, or any other suitable input device. Element 210 of graphical user interface 200 is an exemplary high-level category wager selection mechanism. A user may scroll and/or page, e.g., via “swiping” actions, via a mouse or other pointing device, via cursor control keys, or the like, to select a high level category, e.g., a particular NFL team, for potential wagers. High-level categories may include any category suitable for wagering in a user's jurisdiction. Exemplary high-level categories include sporting events, award shows, elections, trial verdicts, weather events, and most other “live” events. Embodiments in accordance with the present invention are well suited to horizontal scrolling, as illustrated, or vertical scrolling (not shown). According to a selection of a high-level category indicated by high-level category wager selection 210, only proposed wagers conforming to the high-level category, e.g., wagers on or about the San Francisco team, are displayed.

Element 220 of graphical user interface 200 is an exemplary sub-category wager selection mechanism. Dependent from high-level category wager selection 210, sub-category wager selection 220 presents a lower level categorization of proposed wagers. For example, possible wagers on or about the San Francisco team may include wagers on a player or group of players 223, wagers at a team level 222, or any wager related to the team 221. It is appreciated that other types of events may list other sub-categories. Activation of one of the sub-category wager selections 221, 222, or 223, e.g., via touch or “clicking,” highlights that category. For example, FIG. 2 illustrates that the sub-category wager selections “Any” 221 has been selected, as the “Any” 221 button is presented in dark text on a light background, while the “Team” 222 and “Player” 223 buttons are presented with light text on a dark background. According to a selection of a high level category indicated by high level category wager selection 210, and a sub-category wager selection of “any” 221, only proposed wagers conforming to both the high level category, e.g., wagers on or about the San Francisco team, and the sub-category, e.g., any wagers related to the San Francisco team, are displayed.

Graphical user interface 200 comprises a list of available wagers 230. The list is filtered according to the selections of high-level category wager selection 210 and sub-category wager selection 220. If the list 230 is greater than available display space, the list 230 may be scrolled and/or paged in any suitable manner. The list of available wagers 230 includes the odds 240 of each wager.

It is appreciated that several of the items in list 230 appear to be the same. Many users of a wagering system may propose the same wager, and consequently such similar wagers are presented in list 230. In addition, a single user may propose the same wager multiple times, for example, to overcome limits on the number of parties to a specific wager. For example, if a system limits a specific instance of a wager to a maximum of four parties, e.g., four people wager against the initiator of the wager, the initiator may propose the wager multiple times, in order to bet against multiple groups of the maximum number of participants.

Selection icon 250 of graphical user interface 200 allows a user to accept or propose, e.g., create, a wager on any of the indicated contests. When selection icon 250 is in a first visual condition, e.g., a hollow ring, such a condition indicates that a particular wager is available. Touching or otherwise selecting a particular selection icon 250 while in the first visual condition initiates acceptance or proposal of a particular wager. When selection icon 250 is in a second visual condition, e.g., a filled golden circle, such a condition indicates that a particular wager is has previously been entered into by the user. Touching or otherwise selecting a particular selection icon 250 while in the second visual condition may present the wager details, e.g., time remaining in the wager, to the user, present a reminder that the wager is already pending, and/or has no effect, in accordance with embodiments of the present invention.

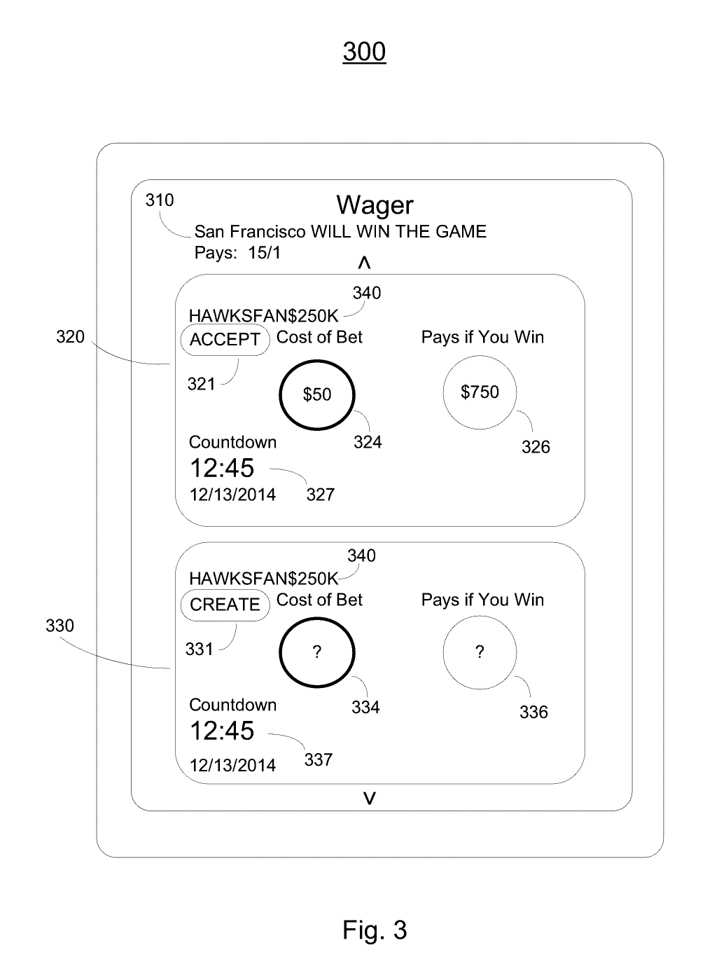

FIG. 3 illustrates an exemplary graphical user interface (GUI) 300 for accepting and/or creating a wager, in accordance with embodiments of the present invention. Graphical user interface 300 comprises a display 310 of the subject wager, e.g., a wager selected from list 230 of FIG. 2. Graphical user interface 300 comprises a plurality of widows 320, 330 related to the subject wager. Window 320 allows a user to accept a wager proposed by another. Window 330 allows a user to create a wager according to the terms of the subject wager, e.g., that San Francisco will win the game at the stated odds. Graphical user interface 300 may comprise more than the illustrated two windows. For example, there may be more than one “accept” window and/or more than one “create” window. If the number of windows is greater than available display space, the windows may be scrolled and/or paged in any suitable manner. In some embodiments, windows 320 and 330 comprise a display 340 of a user's name, ID and/or “handle.”

Window 320 comprises a countdown timer 327 indicating how much time remains to accept the particular wager. For example, countdown timer display 327 may indicate how much time remains until the beginning of a contest. Countdown timer 327 may indicate time remaining to accept a wager in a convenient, scaled format, depending upon the magnitude of the time. For example, if a contest is scheduled for many days from the present, countdown timer 327 may indicate days and hours. If a contest is scheduled to being very soon, countdown timer 327 may indicate minutes and seconds.

Window 320 also comprises a “cost of bet” indication 324 and a “Pays if you win” indication 326. The subject wager may be for a specified amount, e.g., $50. “Pays if you win” indication 326 displays a computation of the potential payout if the user wins the wager, based on the odds of the wager. Window 320 further comprises an “accept” button 321. Touching or otherwise indicting “accept” button 321 will accept the subject wager. A subsequent confirmation screen, e.g., “are you sure?” may be presented, in accordance with embodiments of the present invention.

Window 330 presents a user an opportunity to create a wager according to the subject conditions, e.g., a proposition and odds. Similarly to window 320, window 330 comprises a countdown timer 337. Similarly to window 320, window 330 comprises a “cost of bet” indication 334 and a “pays if you win” indication 336. In contrast to window 320, however, since the bet is in the process of being created, these amounts are unknown. Window 330 further comprises a “create” button 331. Touching or otherwise indicting “create” button 331 will begin a process of creating a wager, which will subsequently appear in lists of available wagers, for example, list of available wagers 230 of FIG. 2.

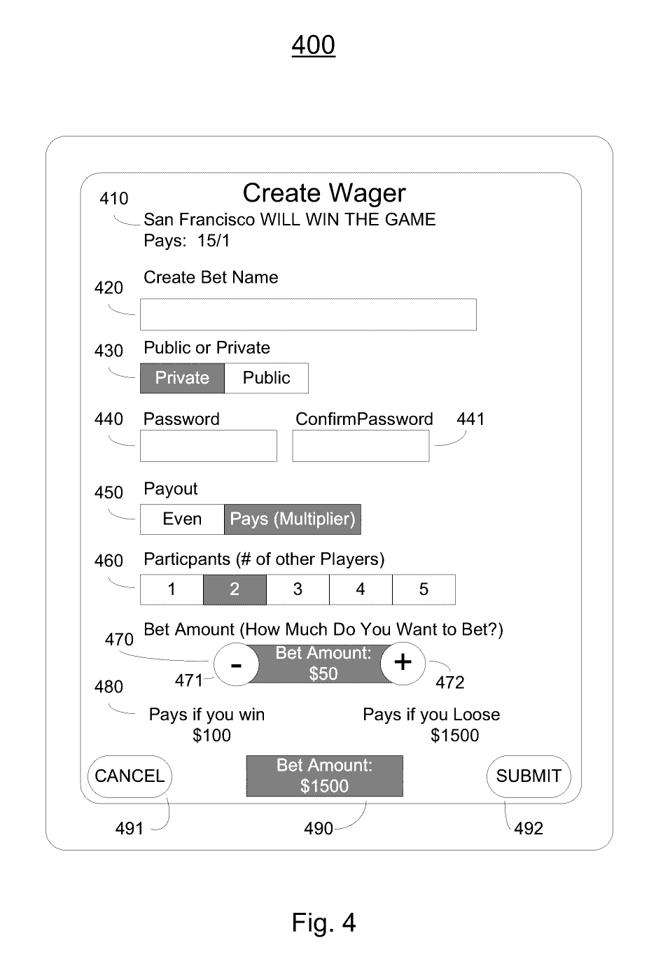

FIG. 4 illustrates an exemplary graphical user interface (GUI) 400 for creating a wager, in accordance with embodiments of the present invention. Graphical user interface 400 is presented responsive to touching or otherwise indicting “create” button 331 of FIG. 3. Graphical user interface 400 comprises a display 410 of the subject wager, including the odds of the wager, if any. Graphical user interface 400 also comprises a field 420 for entry of a bet name.

In addition, graphical user interface 400 comprises a public/private button set 430. Public/private button set 430 allow a user, e.g., via touch input, to select whether a wager is to be public or private. For example, a public wager is viewable and bet-able by all users of a gaming system, whereas a private wager is limited to selected users. Public/private button set 430 also indicates a current status of a wager, e.g., by a combination of text and background brightness and/or color. In the example of FIG. 4, the wager is private.

Responsive to an indication and/or selection of a wager as private, a user is prompted for entry of a password into password field 440 and password confirmation field 441. Such password must be entered for any other user to accept the private wager. Payout indicator 450 confirms whether the wager is for even money or odds. Reviewer—given that the odds are presented in the list 230 (FIG. 2) and at item 410 at the top of FIG. 4, a user cannot select between even money and odds. Please confirm.

Graphical user interface 400 further comprises a number of participants button set 460. Number of participants button set 460 enables a user to select a number of participants in the bet. For example, the user is willing to accept the bet from one to five other players. Number of participants button set 460 also indicates a currently selected maximum number of participants to a wager. In the example of FIG. 4, the creator of the wager is willing to accept the bet from two other players.

Graphical user interface 400 comprises a wager amount field 470. Wager amount field 470 allows a user to change an amount of the bet. For example, a wager amount may be increased by touching plus button 472, and decreased by touching minus button 471. Wager amount field 470 may also operate as a slider, e.g., moving a finger touching within wager amount field 470, toward plus button 472 increases a wager amount, while moving a finger toward minus button 471 decreases a wager amount.

In addition, graphical user interface 400 comprises a payout display field 480. Payout display field 480 displays the possible results of winning or losing the subject wager against the selected number of participants. In the example of FIG. 4, the wager creator has specified a bet of $50 with up to two other users, at 15 to one odds. Accordingly, the initiator may win $100 or loose $1500, based on two $50 bets.

Graphical user interface 400 further comprises a cancel button 491, a submit button 492 and a “bet amount” field 490. Bet amount field 490 displays the total amount a user will bet, e.g., be at risk, if the bet is created and accepted by the maximum allowed users. Touching or otherwise indicating cancel button 491 terminates the current creation of a bet. Touching or otherwise indicating submit button 492 causes the bet to be created. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance. For example, the bet may be subject to a variety of limits, including, game or “house” limits, user credit limits and/or user account balances.

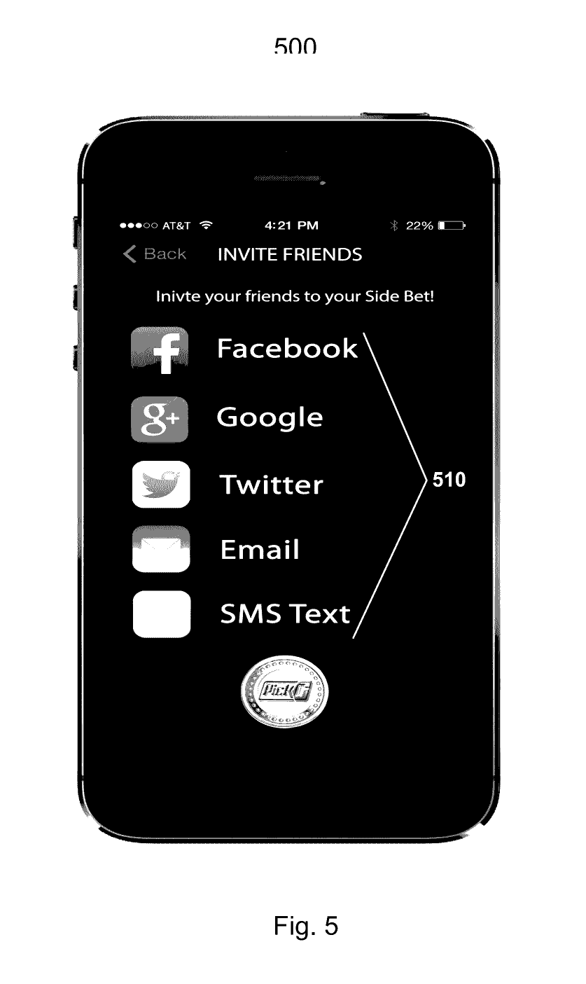

FIG. 5 illustrates an exemplary graphical user interface (GUI) 500 for inviting friends to accept a bet created by a user, in accordance with embodiments of the present invention. Graphical user interface 500 may be presented, for example in response to indicting submit button 492 of FIG. 4. Graphical user interface 500 comprises a list 510 of electronic communication systems including, for example, social media, electronic mail, and/or short message service (“SMS”) communications. Upon indicating a member of list 510, corresponding software, e.g., an email application, is initiated with a prefilled message inviting one or more individuals or groups, for example, from a player's address book or “friends” list, and/or the like, to accept the wager just created by the player.

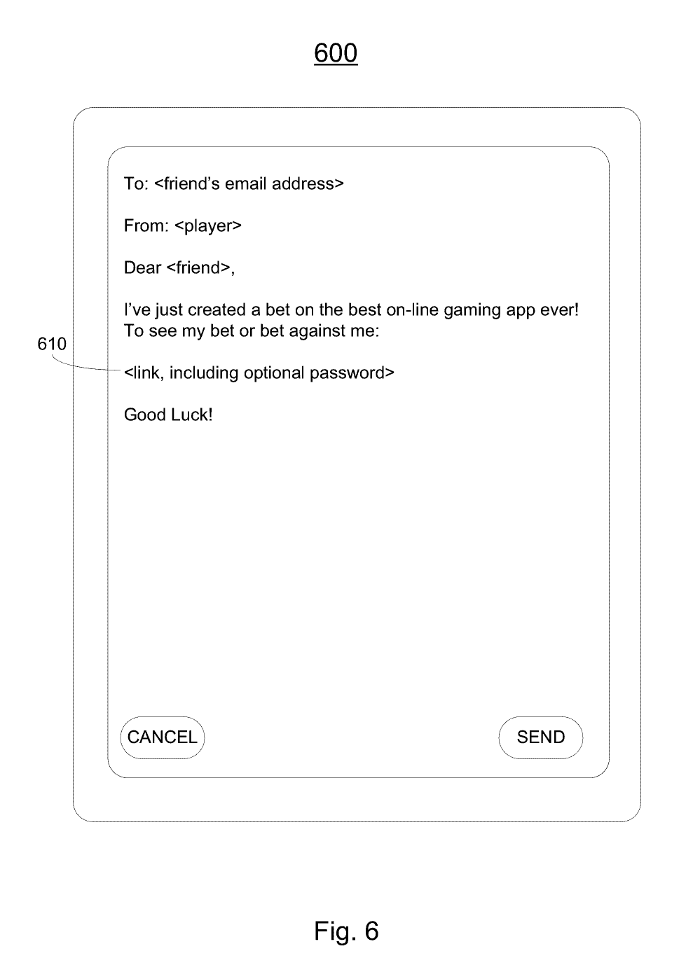

FIG. 6 illustrates an exemplary prefilled message 600 inviting one or more individuals or groups to accept a wager, in accordance with embodiments of the present invention. Message 600 comprises a link 610 for directing a recipient's electronic systems to the wager. The link 610 may comprise a universal resource locator (URL) in some embodiments. If the wager is a private wager, the link also comprise a password, e.g., to automate access to the private wager, in some embodiments. The message 600 may be customized by the user, e.g., by editing, in some embodiments.

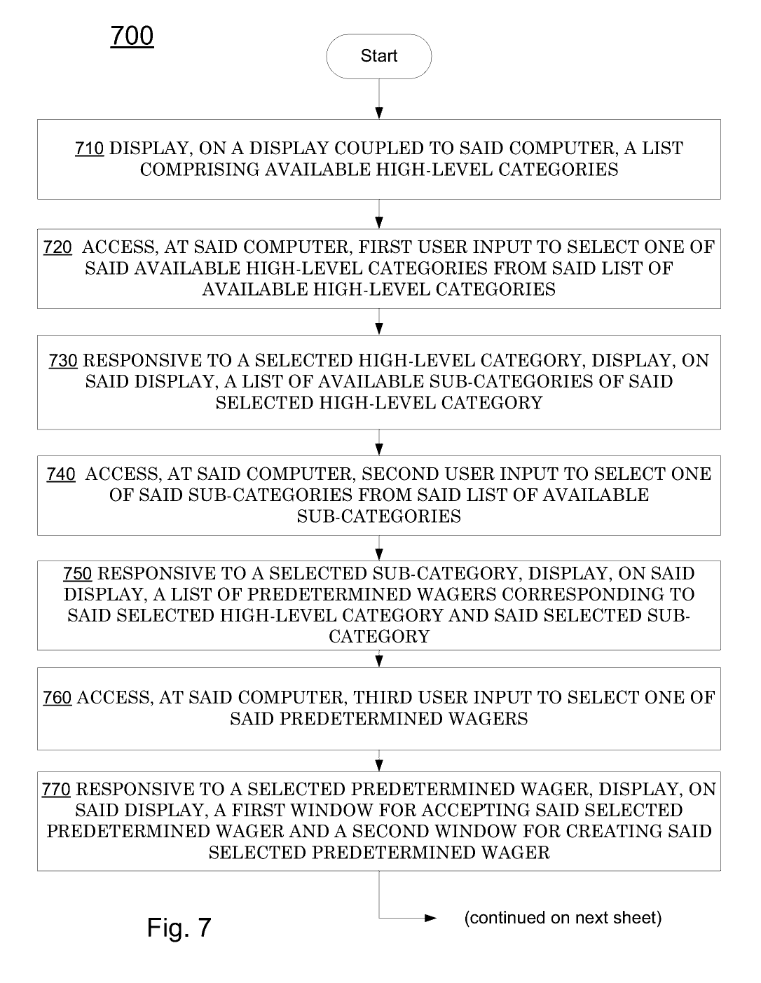

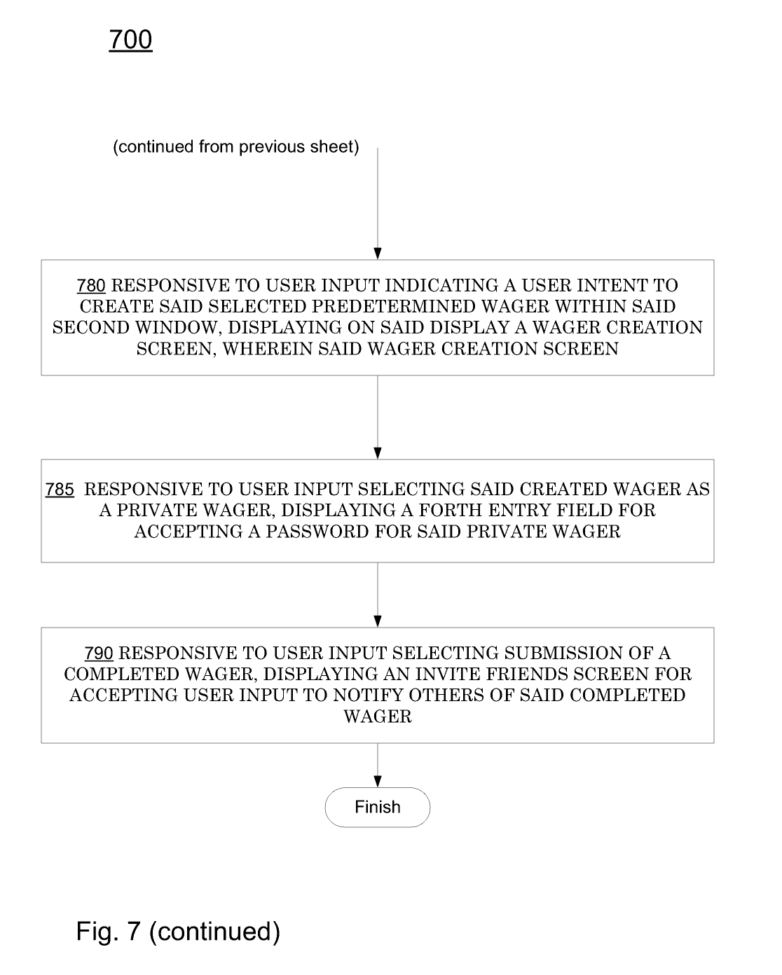

FIG. 7 illustrates an exemplary computer-implemented method 700, in accordance with embodiments of the present invention. In 710, a list, e.g., element 210 of FIG. 2, comprising available high-level categories is displayed on a display coupled to the computer. The available high-level categories correspond to events that are subject to wagers within a gaming system. In 720, first user input, for example, scrolling or paging along a perceived horizontal dimension, to select one of the available high-level categories from the list of available high-level categories is accessed at the computer.

In 730, responsive to a selected high-level category, a list of available sub-categories of the selected high-level category, e.g., element 220 of FIG. 2, is displayed on the display. In 740, second user input, for example, touching, clicking with a mouse and the like, to select one of the sub-categories from the list of available sub-categories is accessed at the computer. In 750, responsive to a selected sub-category, a list of predetermined wagers corresponding to the selected high-level category and the selected sub-category, e.g., list 230, is displayed on the display. In 760, third user input to select one of the predetermined wagers is accessed at the computer. The third user input may comprise touching or indicating a hollow circle icon, e.g., icon 250 of FIG. 2. In 770, responsive to a selected predetermined wager, a first window for accepting the selected predetermined wager, e.g., window 320 of FIG. 3, and a second window for creating the selected predetermined wager, e.g., window 330 of FIG. 3, are displayed on the display. The first window may display a cost of the selected predetermined wager, e.g., “cost of bet” indication 324 of FIG. 3, and a potential winning amount of the selected predetermined wager, e.g., “Pays if you win” indication 326 of FIG. 3, reflecting odds of the bet. The first window may also display a countdown timer, e.g., countdown timer 327 of FIG. 3, indicating time remaining to accept the selected predetermined wager.

In optional 780, responsive to user input indicating a user intent to create the selected predetermined wager within the second window, for example, touching “create” button 331 of FIG. 3, a wager creation screen, for example graphical user interface 400 of FIG. 4, is displayed on the display. The wager creation screen may include a first entry field, e.g., number of participants button set 460 of FIG. 4, for accepting user input to select and indicate a number of participants in a created wager, a second entry field, e.g., wager amount field 470 of FIG. 4, for accepting user input to select and indicate an amount of the created wager, a display field, e.g., payout display field 480 of FIG. 4, to indicate a payout for winning the created wager and a cost for loosing the created wager, wherein the cost for loosing the created wager reflects odds and number of participants of the created wager and/or a third entry field, e.g., public/private button set 430 of FIG. 4, for accepting user input to select and indicate whether the created wager is a public or private wager.

In optional 785, responsive to user input selecting the created wager as a private wager, a forth entry field, e.g., password field 440 of FIG. 4, for accepting a password for the private wager is displayed on the display. In optional 790, responsive to user input, for example, touching or indicating submit button 492 of FIG. 4, selecting submission of a completed wager, an invite friends screen, e.g., graphical user interface 500 of FIG. 5, for accepting user input to notify others of the completed wager is displayed on the display. The invite friends screen comprises a plurality of icons for electronic communication systems. The icons may or may not reflect a service provider's trade dress.

Embodiments in accordance with the present invention provide systems and methods for accepting and creating electronic wagers. In addition, embodiments in accordance with the present invention provide systems and methods for accepting and creating electronic wagers that enable a player to create a wager in an on-line gaming system. Also, embodiments in accordance with the present invention provide systems and methods for accepting and creating electronic wagers that utilize effective and intuitive graphical user interfaces. Further, embodiments in accordance with the present invention provide systems and methods for accepting and creating electronic wagers that are compatible and complementary with existing systems and methods of on-line and/or mobile gaming.

Various embodiments of the invention are thus described. While the present invention has been described in particular embodiments, it should be appreciated that the invention should not be construed as limited by such embodiments, but rather construed according to the below claims.

What is claimed is:

1. A computer-implemented method comprising:
displaying, on a display coupled to said computer, a list comprising available high-level categories, wherein said available high-level categories correspond to events that are subject to wagers within a gaming system;
accessing, at said computer, first user input to select one of said available high-level categories from said list of available high-level categories;
responsive to a selected high-level category, displaying, on said display, a list of available sub-categories of said selected high-level category;
accessing, at said computer, second user input to select one of said sub-categories from said list of available sub-categories;
responsive to a selected sub-category, displaying, on said display, a list of predetermined wagers corresponding to said selected high-level category and said selected sub-category;
accessing, at said computer, third user input to select one of said predetermined wagers; and
responsive to a selected predetermined wager, displaying, on said display, a first window for accepting said selected predetermined wager and a second window for creating said selected predetermined wager.

2. The computer-implemented method of claim 1 wherein said first window displays a cost of said selected predetermined wager and a potential winning amount of said selected predetermined wager reflecting odds of said bet.

3. The computer-implemented method of claim 1 wherein said first window displays a countdown timer indicating time remaining to accept said selected predetermined wager.

4. The computer-implemented method of claim 1 further comprising:
responsive to user input indicating a user intent to create said selected predetermined wager within said second window, displaying on said display a wager creation screen, wherein said wager creation screen comprises:
a first entry field for accepting user input to select and indicate a number of participants in a created wager;
a second entry field for accepting user input to select and indicate an amount of said created wager; and
a display field to indicate a payout for winning said created wager and a cost for loosing said created wager, wherein said cost for loosing said created wager reflects odds and number of participants of said created wager.

5. The computer-implemented method of claim 4 wherein said wager creation screen further comprises:
a third entry field for accepting user input to select and indicate whether said created wager is a public or private wager.

6. The computer-implemented method of claim 5 further comprising:
responsive to user input selecting said created wager as a private wager, displaying a forth entry field for accepting a password for said private wager.

7. The computer-implemented method of claim 6 further comprising:
responsive to user input selecting submission of a completed wager, displaying an invite friends screen for accepting user input to notify others of said completed wager, wherein said invite friends screen comprises a plurality of icons for electronic communication systems.

8. An article of manufacture including a computer readable medium having instructions stored thereon that, responsive to execution by an electronic system, cause said electronic system to perform operations comprising:
displaying, on a display coupled to said computer, a list comprising available high-level categories, wherein said available high-level categories correspond to events that are subject to wagers within a gaming system;
accessing, at said computer, first user input to select one of said available high-level categories from said list of available high-level categories;
responsive to a selected high-level category, displaying, on said display, a list of available sub-categories of said selected high-level category;
accessing, at said computer, second user input to select one of said sub-categories from said list of available sub-categories;
responsive to a selected sub-category, displaying, on said display, a list of predetermined wagers corresponding to said selected high-level category and said selected sub-category;
accessing, at said computer, third user input to select one of said predetermined wagers; and
responsive to a selected predetermined wager, displaying, on said display, a first window for accepting said selected predetermined wager and a second window for creating said selected predetermined wager.

9. The article of manufacture of claim 8 wherein said first window displays a cost of said selected predetermined wager and a potential winning amount of said selected predetermined wager reflecting odds of said bet.

10. The article of manufacture of claim 8 wherein said first window displays a countdown timer indicating time remaining to accept said selected predetermined wager.

11. The article of manufacture of claim 8 wherein said operations further include:
responsive to user input indicating a user intent to create said selected predetermined wager within said second window, displaying on said display a wager creation screen, wherein said wager creation screen comprises:
a first entry field for accepting user input to select and indicate a number of participants in a created wager;
a second entry field for accepting user input to select and indicate an amount of said created wager; and
a display field to indicate a payout for winning said created wager and a cost for loosing said created wager, wherein said cost for loosing said created wager reflects odds and number of participants of said created wager.

12. The article of manufacture of claim 8 wherein said list comprising available high-level categories may be scrolled horizontally to view other members of said list.

13. The article of manufacture of claim 8 wherein said list of available sub-categories indicates a selected sub-category by text and background highlighting.

14. The article of manufacture of claim 8 wherein said third user input is indicated by a user touch of a hollow circle icon to the left of a predetermined wager.

15. An electronic system comprising:
one or more processors coupled to a bus;
a memory coupled to said one or more processors, wherein said memory comprises a gaming application;
a position determining system coupled to said bus operable to determine a geolocation of said electronic system;
a graphical user interface coupled to said bus, wherein said graphical user interface is configured to:
display a list comprising available high-level categories, wherein said available high-level categories correspond to events that are subject to wagers within a gaming system;
access first user input to select one of said available high-level categories from said list comprising available high-level categories;
responsive to a selected high-level category, display a list of available sub-categories of said selected high-level category;
access second user input to select one of said sub-categories from said list of available sub-categories;
responsive to a selected sub-category, display a list of predetermined wagers corresponding to said selected high-level category and said selected sub-category;
access third user input to select one of said predetermined wagers; and
responsive to a selected predetermined wager, display a first window for accepting said selected predetermined wager and a second window for creating said selected predetermined wager.

16. The electronic system of claim 15 wherein said graphical user interface is further configured to:
display, in said first window, a cost of said selected predetermined wager and a potential winning amount of said selected predetermined wager reflecting odds of said bet.

17. The electronic system of claim 15 wherein said graphical user interface is further configured to:
display, in said first window, a countdown timer indicating time remaining to accept said selected predetermined wager.

18. The electronic system of claim 15 wherein said graphical user interface is further configured to:
responsive to user input indicating a user intent to create said selected predetermined wager within said second window, display a wager creation screen, wherein said wager creation screen comprises:
a first entry field for accepting user input to select and indicate a number of participants in a created wager;
a second entry field for accepting user input to select and indicate an amount of said created wager; and
a display field to indicate a payout for winning said created wager and a cost for loosing said created wager, wherein said cost for loosing said created wager reflects odds and number of participants of said created wager.

19. The electronic system of claim 15 wherein said graphical user interface comprises a touch interface.

20. The electronic system of claim 15 wherein said third user input is indicated at a hollow circle icon aligned with a predetermined wager.

21. A computer-implemented method comprising:
displaying, on a display coupled to said computer, a list comprising available events that are subject to wagers within a gaming system;
accessing, at said computer, first user input to select one of said available events;
responsive to said first user input, displaying a list of predetermined wagers corresponding to said one of said available events; and
accessing, at said computer, second user input to select one of said predetermined wagers.

22. The computer-implemented method of claim 21 further comprising:
displaying a cost of said selected predetermined wager and a potential winning amount of said selected predetermined wager reflecting odds of said bet.

23. The computer-implemented method of claim 21 further comprising:
displaying a countdown timer indicating time remaining to accept said selected predetermined wager.

24. The computer-implemented method of claim 21 further comprising:
displaying an entry field for accepting user input to select and indicate a number of participants in a created wager.

25. The computer-implemented method of claim 21 further comprising:
displaying an entry field for accepting user input to select and indicate whether a created wager is a public or private wager.

26. The computer-implemented method of claim 25 further comprising:
responsive to user input selecting said created wager as a private wager, displaying a forth entry field for accepting a password for said private wager.
